(19) United States
(12) Patent Application Publication
(10) Pub. No.: US 2025/0391344 A1
(43) Pub. Date: Dec. 25, 2025

(54) DISPLAY DEVICE AND ELECTRONIC DEVICE INCLUDING THE SAME

(71) Applicant: Samsung Display Co., Ltd., Yongin-si (KR)

(72) Inventors: Hyun Sik YOON, Yongin-si (KR); Jong Woon KIM, Yongin-si (KR); Ki Hyun SUNG, Yongin-si (KR); Ki Hong SONG, Yongin-si (KR); Ye Seul LEE, Yongin-si (KR)

(21) Appl. No.: 19/230,217

(22) Filed: Jun. 6, 2025

(30) Foreign Application Priority Data
Jun. 19, 2024 (KR) 10-2024-0079322
Aug. 6, 2024 (KR) 10-2024-0104573

(51) Int. Cl. G09G 3/32; G09G 3/3266; G09G 3/3275

(52) U.S. Cl. CPC G09G 3/32; G09G 3/3266; G09G 3/3275; G09G 2310/0267; G09G 2310/0275; G09G 2310/08; G09G 2320/0257; G09G 2320/0276; G09G 2330/021

(57) ABSTRACT

A display device includes: a display panel including a plurality of pixels; a scan driver connected to the display panel through a plurality of scan lines; a data driver configured to provide a data signal corresponding to each of the plurality of pixels to the display panel; a timing controller configured to receive image data and to control driving of the scan driver and the data driver to display an image corresponding to the image data; and a current sensor configured to sense a current flowing through the plurality of scan lines, wherein the timing controller is configured to correct the image data based on the current flowing through the plurality of scan lines.

### CROSS-REFERENCE TO RELATED APPLICATION

The present application claims priority to and the benefit of Korean Patent Application No. 10-2024-0079322, filed on Jun. 19, 2024, in the Korean Intellectual Property Office, and Korean Patent Application No. 10-2024-0104573 filed on Aug. 6, 2024, in the Korean Intellectual Property Office, the entire disclosures of which are incorporated herein by reference.

### BACKGROUND

### 1. Field

Aspects of embodiments of the present disclosure relate to an electronic device including the same.

### 2. Description of the Related Art

As information technology has developed, importance of a display device, which is a connection medium between a user and information, has been highlighted. Accordingly, the use of display devices such as a liquid crystal display device, an organic light emitting display device, and the like has been increasing.

The display device includes a plurality of pixels connected to data lines, scan lines, and sensing scan lines. The pixel includes a pixel circuit and a light emitting element, and the light emitting element emits light with a predetermined luminance in response to a driving current supplied from a driving transistor through the pixel circuit.

The above information disclosed in this Background section is only for enhancement of understanding of the background of the invention and therefore it may contain information that does not form the prior art.

### SUMMARY

An aspect of the present disclosure is to provide a display device and an electronic device including the same that may alleviate the visibility of a bright line or a dark line when coupling capacitance is formed between scan lines or sensing scan lines connected to a display panel. According to some embodiments of the present disclosure, there is provided a display device including: a display panel including a plurality of pixels; a scan driver connected to the display panel through a plurality of scan lines; a data driver configured to provide a data signal corresponding to each of the plurality of pixels to the display panel; a timing controller configured to receive image data and to control driving of the scan driver and the data driver to display an image corresponding to the image data; and a current sensor configured to sense a current flowing through the plurality of scan lines, wherein the timing controller is configured to correct the image data based on the current flowing through the plurality of scan lines.

In some embodiments, the scan driver may be configured to apply a set reference voltage to a selected scan line among the plurality of scan lines, and the current sensor may be configured to sense currents flowing through adjacent scan lines adjacent to the selected scan line.

In some embodiments, the current sensor may be configured to: generate coupling current information by adding values of the currents flowing through the adjacent scan lines, and transmit the coupling current information to the timing controller.

In some embodiments, the timing controller may be configured to: generate a correction coefficient corresponding to the selected scan line based on the coupling current information, and correct the image data based on the correction coefficient.

In some embodiments, the timing controller may include: a correction coefficient generator configured to receive coupling current information corresponding to the selected scan line and to generate the correction coefficient corresponding to the selected scan line with reference to a first lookup table; a correction coefficient storage configured to store the generated correction coefficient; and a data generator configured to generate corrected grayscale data by multiplying grayscale data corresponding to the selected scan line among the image data by the correction coefficient.

In some embodiments, the correction coefficient storage may be configured to store a plurality of correction coefficient values respectively corresponding to the plurality of scan lines in a second lookup table.

In some embodiments, at least one of the plurality of correction coefficient values stored in the second lookup table may have a value greater than 0 and less than 1.

In some embodiments, the scan driver may be connected to the display panel through the plurality of scan lines and a plurality of sensing scan lines, the current sensor may be configured to sense a current flowing through the plurality of scan lines and a current flowing through the plurality of sensing scan lines, and the timing controller may be configured to correct the image data based on the currents flowing through the plurality of scan lines and the plurality of sensing scan lines.

According to some embodiments of the disclosure, there is provided a display device including: a display panel including a plurality of pixels; a scan driver connected to the display panel through a plurality of scan lines and a plurality of sensing scan lines; a data driver is configured to provide a data signal corresponding to each of the plurality of pixels to the display panel; a timing controller is configured to receive image data and to control driving of the scan driver and the data driver to display an image corresponding to the image data; and a current sensor configured to sense a current flowing through the plurality of sensing scan lines, wherein the timing controller is configured to correct the image data based on the current flowing through the plurality of sensing scan lines.

In some embodiments, the scan driver may be configured to apply a set reference voltage to a selected sensing scan line among the plurality of sensing scan lines, and the current sensor may be configured to sense currents flowing through adjacent sensing scan lines adjacent to the selected sensing scan line.

In some embodiments, the current sensor may be configured to: generate coupling current information by adding values of the currents flowing through the adjacent sensing scan lines, and transmit the coupling current information to the timing controller.

In some embodiments, the timing controller may be configured to: generate a correction coefficient corresponding to the selected sensing scan line based on the coupling current information, and correct the image data based on the correction coefficient.

In some embodiments, the timing controller may include: a correction coefficient generator configured to receive coupling current information corresponding to the selected sensing scan line and generate the correction coefficient corresponding to the selected sensing scan line with reference to a first lookup table; a correction coefficient storage configured to store the generated correction coefficient; and a data generator configured to generate corrected grayscale data by multiplying grayscale data corresponding to the selected sensing scan line among the image data by the correction coefficient.

In some embodiments, the correction coefficient storage may be configured to store a plurality of correction coefficient values respectively corresponding to the plurality of sensing scan lines in a second lookup table.

In some embodiments, at least one of the plurality of correction coefficient values stored in the second lookup table may have a value greater than 1.

According to some embodiments of the disclosure, there is provided an electronic device including: a display panel including a plurality of pixels; a scan driver connected to the display panel through a plurality of scan lines; a data driver configured to provide a data signal corresponding to each of the plurality of pixels to the display panel; a controller configured to receive image data and control driving of the scan driver and the data driver to display an image corresponding to the image data; and a power module configured to sense a current flowing through the plurality of scan lines, wherein the controller is configured to correct the image data based on the current flowing through the plurality of scan lines.

In some embodiments, the controller may include: a correction coefficient generator configured to receive coupling current information corresponding to a selected scan line among the plurality of scan lines and generate the correction coefficient corresponding to the selected scan line with reference to a first lookup table; a correction coefficient storage configured to store the generated correction coefficient; and a data generator configured to generate corrected grayscale data by multiplying grayscale data corresponding to the selected scan line among the image data by the correction coefficient.

In some embodiments, the correction coefficient storage may be configured to store a plurality of correction coefficient values respectively corresponding to the plurality of scan lines in a second lookup table.

In some embodiments, at least one of the plurality of correction coefficient values stored in the second lookup table may have a value greater than 0 and less than 1.

In some embodiments, the scan driver may be connected to the display panel through the plurality of scan lines and a plurality of sensing scan lines, the electronic device may further include a current sensor configured to sense a current flowing through the plurality of scan lines and a current flowing through the plurality of sensing scan lines, and the controller may be configured to correct the image data based on the currents flowing through the plurality of scan lines and the plurality of sensing scan lines.

According to some embodiments of the disclosure, there is provided an electronic device including: a processor; a memory an input module; and a display module including: a display panel including a plurality of pixels; a scan driver connected to the display panel through a plurality of scan lines; a data driver configured to provide a data signal corresponding to each of the plurality of pixels to the display panel; a timing controller configured to receive image data and to control driving of the scan driver and the data driver to display an image corresponding to the image data; and a current sensor configured to sense a current flowing through the plurality of scan lines, wherein the timing controller is configured to correct the image data based on the current flowing through the plurality of scan lines.

Objectives of the present disclosure are not limited to the objectives mentioned above, and other technical objectives that are not mentioned may be clearly understood to a person of an ordinary skill in the art using the following description.

In the display device and the electronic device including the same according to some embodiments of the present disclosure, when coupling capacitance is formed between scan lines or sensing scan lines connected to a display panel, it is possible to alleviate the visibility of bright or dark lines.

However, the effects of the present disclosure are not limited to the above-described effects, and may be variously extended without departing from the spirit and scope of the present disclosure.

### BRIEF DESCRIPTION OF THE DRAWINGS

FIG. 1 illustrates a display device according to some embodiments of the present disclosure.

FIG. 2 illustrates a pixel included in the display device of FIG. 1 according to some embodiments of the present disclosure.

FIG. 3 is a drawing for explaining coupling capacitance between scan lines in the display device of FIG. 1 according to some embodiments of the present disclosure.

FIG. 4 illustrates a timing diagram of a current of an adjacent scan line by coupling capacitance when a voltage of the scan line changes according to some embodiments of the present disclosure.

FIG. 5 illustrates a display device according to some other embodiments of the present disclosure.

FIG. 6 is a drawing for explaining a method for sensing a coupling current in the display device of FIG. 5 according to some embodiments of the present disclosure.

FIG. 7 illustrates a block diagram of a timing controller of FIG. 3 according to some embodiments of the present disclosure.

FIG. 8 illustrates a block diagram of a data generator of FIG. 7 according to some embodiments of the present disclosure.

FIG. 9 illustrates a flowchart of an operating method of a display device according to some other embodiments of the present disclosure.

FIG. 10 illustrates a flowchart of an operating method of a display device according to some other embodiments of the present disclosure.

FIG. 11 illustrates an electronic device according to some other embodiments of the present disclosure.

### DETAILED DESCRIPTION SOME EMBODIMENTS

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

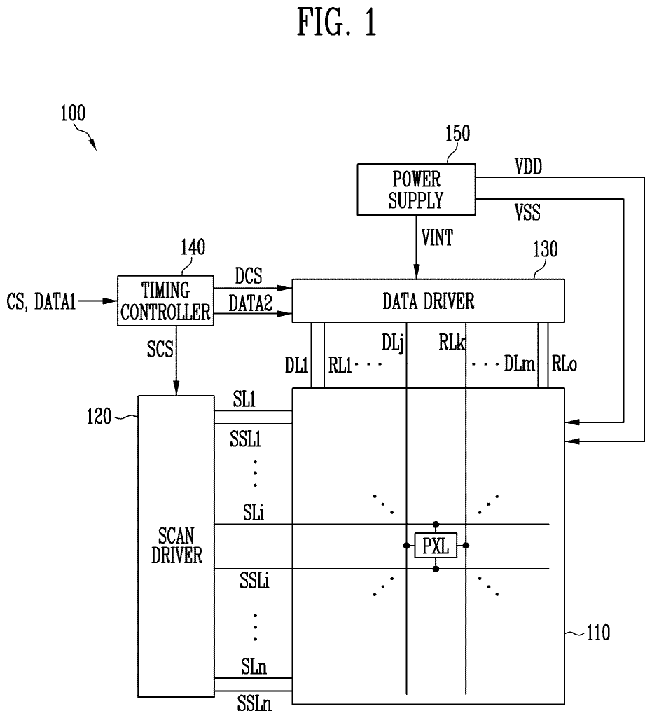

FIG. 1 illustrates a display device according to some embodiments of the present disclosure.

Referring to FIG. 1, a display device 100 may include a display portion 110 (or display panel), a scan driver 120 (or gate driver), a data driver 130 (or source driver), a timing controller 140, and a power supply 150. The scan driver 120, the data driver 130, the timing controller 140, and the power supply 150 may configure a driving device for driving the display portion 110.

The display portion 110 may display an image. The display portion 110 may include scan lines SL1 to SLn, data lines DL1 to DLm, readout lines RL1 to RLo (or sensing lines), and a pixel PXL (where each of n and m is a positive integer, and o is a positive integer less than or equal to m). In addition, the display portion 110 may further include sensing scan lines SSL1 to SSLn.

The pixel PXL may be disposed or positioned in an area (e.g., a pixel area) partitioned by the scan lines SL1 to SLn and the data lines DL1 to DLm.

The pixel PXL may be connected to one of the scan lines SL1 to SLn and one of the data lines DL1 to DLm. In addition, the pixel PXL may be connected to one of the sensing scan lines SSL1 to SSLn and one of the readout lines RL1 to RLo.

For example, the pixel PXL disposed at an i-th row and a j-th column may be connected to an i-th scan line SLi, an i-th sensing scan line SSLi, a j-th data line DLj, and a k-th readout line RLk (where each of i and j is a positive integer, and k is an integer less than or equal to j). In addition, the pixel PXL may be electrically connected between a first power line to which a first power voltage VDD is applied and a second power line to which a second power voltage VSS is applied. Here, the first and second power voltages VDD and VSS may be power voltages or driving voltages suitable for the operation of the pixel PXL, and the first power voltage VDD may have a voltage level higher than that of the second power voltage VSS. For example, the second power voltage VSS may be about 0 V, and the first power voltage VDD may be about 20 V. The first and second power voltages VDD and VSS may be provided from the power supply 150 to the display portion 110.

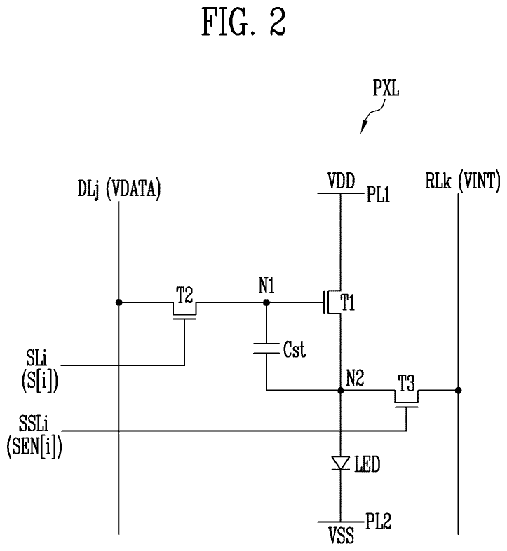

The pixel PXL may be initialized using a third power voltage VINT (or initialization voltage) provided through the k-th readout line RLk in response to the sensing scan signal provided through the i-th sensing scan line SSLi. The pixel PXL may store or record a data signal (or a data voltage) provided through the j-th data line DLj in response to the scan signal provided through the i-th scan line SLi and may emit light with a luminance corresponding to the stored data signal. For example, the voltage level of the third power voltage VINT may be set lower than the operating point (or threshold voltage) of the light emitting element in the pixel PXL. For example, the third power voltage VINT may be about 2 V to about 3 V. The third power voltage VINT may be provided to the display portion 110 from the power supply 150 through the data driver 130. A detailed configuration of the pixel PXL will be described later with reference to FIG. 2.

The scan driver 120 may generate a scan signal (or scan signals) based on a scan control signal SCS, and sequentially provide the scan signal to the scan lines SL1 to SLn. Here, the scan control signal SCS may include a start signal, clock signals, and the like, and may be provided from the timing controller 140 to the scan driver 120. For example, the scan driver 120 may be implemented as a shift register that generates and outputs the scan signals by sequentially shifting the start signal in the form of pulses using the clock signals. For example, similar to the method of generating the scan signal, the scan driver 120 (e.g., scan driving unit) may generate a sensing scan signal and sequentially provide the sensing scan signal to the sensing scan lines SSL1 to SSLn.

The scan driver 120 may be formed together with the pixel PXL on the display portion 110. However, the present disclosure is not limited thereto, and for example, the scan driver 120 may be mounted on a circuit film and connected to the timing controller 140 (e.g., timing control unit) via at least one circuit film and a printed circuit board.

The data driver 130 may generate data signals (or data voltages) based on image data DATA2 and a data control signal DCS provided from the timing controller 140, and may transmit the data signals to the display portion 110 (or the pixel PXL) through the data lines DL1 to DLm. Here, the data control signal DCS may be a signal that controls an operation of the data driver 130, and may include a load signal (or data enable signal), a horizontal start signal, and/or a data clock signal that direct the output of a valid data signal. For example, the data driver 130 may include a shift register that generates a sampling signal by shifting the horizontal start signal in synchronization with the data clock signal; a latch that latches the image data DATA2 in response to the sampling signal; a digital-to-analog converter (or decoder) that converts the latched image data (e.g., data in digital form) into data signals in analog form; and buffers (or amplifiers) that output the data signals to the data lines DL1 to DLm. In addition, the data driver 130 may provide the third power voltage VINT (that is, the third power voltage VINT provided from the power supply 150) to the display portion 110 (or the pixel PXL) through the readout lines RL1 to RLo.

In some embodiments, in a separate sensing mode or sensing period (e.g., in a sensing period allocated to sense electrical characteristics of the pixel PXL, such as a threshold voltage and/or mobility of a driving transistor included in the pixel PXL), the data driver 130 may provide a test signal (or a test voltage) to the pixel PXL through the data lines DL1 to DLm and receive a sensing signal from the pixel PXL through the readout lines RL1 to RLo. The sensing signal may be used in the data driver 130 or the timing controller 140 to compensate for the electrical characteristic (or characteristic deviation) of the pixel PXL. The configuration of the data driver 130 sensing the electrical characteristics of the pixel PXL will be described later with reference to FIG. 2.

In some embodiments, the sensing period may include a first section (or an individual sensing period) and a second section (or a reset period). In some embodiments, the data driver 130 may provide a test signal to a target pixel (that is, a pixel PXL whose electrical characteristics are to be sensed, or a data line connected to the pixel PXL) in the first period, while it may provide a first turn-off voltage (or a first off voltage) to the remaining pixels (that is, pixels excluding the target pixel, or data lines connected to the remaining pixels). In some embodiments, the data driver 130 may provide a second turn-off voltage (or a second off voltage) to the remaining pixels (and target pixel) in the second period. For example, the test signal may have a voltage level for turning on the driving transistor provided in the pixel PXL, and the first turn-off voltage and the second turn-off voltage may have a voltage level for turning off the driving transistor. The first turn-off voltage may have a voltage level lower than that of the second turn-off voltage.

The data driver 130 may be mounted on a circuit film, and may be connected to the timing controller 140 via at least one printed circuit board and/or cable.

The timing controller 140 may receive input image data DATA1 and a control signal CS from an external source (e.g., a graphic processor), generate the scan control signal SCS and the data control signal DCS based on the control signal CS, and convert the input image data DATA1 to generate the image data DATA2. For example, the control signal CS may include a vertical synchronization signal, a horizontal synchronization signal, a reference clock signal, and the like. The vertical synchronization signal may indicate the start of frame data (that is, data corresponding to a frame section in which one frame image is displayed), and the horizontal synchronization signal may indicate the start of a data row (that is, one of a plurality of data rows included in the frame data). For example, the timing controller 140 may convert the input image data DATA1 into the image data DATA2 having a format that matches the pixel array in the display portion 110.

The power supply 150 may supply the first power voltage VDD and the second power voltage VSS to the display portion 110. In addition, the power supply 150 may provide the third power voltage VINT to the data driver 130. In addition, the power supply 150 may provide a power voltage suitable for driving at least one of the scan driver 120, the data driver 130, and the timing controller 140. The power supply 150 may be implemented as a power management integrated circuit (PMIC).

At least one of the scan driver 120, the data driver 130, the timing controller 140, and the power supply 150 may be formed in (e.g., integrated with) the display portion 110, or may be implemented as an integrated circuit to be connected to the display portion 110 in the form of a tape carrier package. In addition, at least two of the scan driver 120, the data driver 130, the timing controller 140, and the power supply 150 may be implemented as one integrated circuit. For example, the data driver 130 and the timing controller 140 may be implemented as a single integrated circuit.

FIG. 2 illustrates a pixel included in the display device of FIG. 1 according to some embodiments of the present disclosure. A pixel PXL disposed in an i-th row and a j-th column is illustrated as an example.

Referring to FIG. 2, the pixel PXL may be connected to an i-th scan line SLi, a j-th data line DLj, an i-th sensing scan line SSLi, and a k-th readout line RLk.

The pixel PXL may include a light emitting element LED, a first transistor T1 (or a driving transistor), a second transistor T2 (or a first switching transistor), a third transistor T3 (or a sensing transistor, a second switching transistor, an initialization transistor), and a storage capacitor Cst. Each of the first transistor T1, the second transistor T2, and the third transistor T3 may be a thin film transistor including an oxide semiconductor, but is not limited thereto, and for example, at least some of the first transistor T1, the second transistor T2, and the third transistor T3 may include a polysilicon semiconductor or may be implemented as an N-type semiconductor or a P-type semiconductor.

A first electrode (e.g., an anode electrode) of the light emitting element LED may be connected (e.g., electrically connected) to a second node N2 (or a second electrode of the first transistor T1). The first electrode of the light emitting device LED may be connected (e.g., electrically connected) to a first power line PL1 via the first transistor T1. The first power voltage VDD may be applied to the first power line PL1. A second electrode (e.g., a cathode electrode) of the light emitting element LED may be connected to a second power line PL2. The second power voltage VSS may be applied to the second power line PL2. The light emitting element LED may generate light of a set luminance (e.g., a preset or predetermined luminance) in response to an amount of current (or a driving current) supplied from the first transistor T1. The light emitting element LED may be configured as an organic light emitting diode, or may be configured as an inorganic light emitting diode, such as a micro light emitting diode (LED) or a quantum dot light emitting diode. In addition, the light emitting element may be a light emitting diode made of a composite of organic and inorganic materials.

A first electrode (e.g., a drain electrode) of the first transistor T1 may be connected to the first power line PL1, and a second electrode (e.g., the source electrode) thereof may be connected to the second node N2 (or the anode electrode of the light emitting element LED). A gate electrode of the first transistor T1 may be connected to a first node N1. The first transistor T1 may control an amount of current flowing to the light emitting element LED in response to a voltage of the first node N1 (or a gate-source voltage applied between the second electrode and the gate electrode of the first transistor T1).

A first electrode of the second transistor T2 may be connected to the j-th data line DLj, and a second electrode thereof may be connected to the first node N1. A gate electrode of the second transistor T2 may be connected to the i-th scan line SLi. When an i-th scan signal S[i] is supplied to the i-th scan line SLI, the second transistor T2 may be turned on to transmit a data signal VDATA (or a data voltage) from the j-th data line DLj to the first node N1.

The storage capacitor Cst may be formed or connected between the first node N1 and the first electrode of the light emitting element LED. The storage capacitor Cst may store a voltage of the first node N1. For example, a charge corresponding to the voltage of the first node N1 may be charged in the storage capacitor Cst.

A first electrode of the third transistor T3 may be connected to the second node N2 (or the second electrode of the first transistor T1), and a second electrode of the third transistor T3 may be connected to the kth readout line RLk. A gate electrode of the third transistor T3 may be connected to the i-th sensing scan line SSLi. The third transistor T3 may connect the second node N2 to the k-th readout line RLk in response to a sensing scan signal SEN[i]. For example, the third power voltage VINT applied to the k-th readout line RLk may be applied to the second node N2. The voltage of the second node N2 or the first electrode of the light emitting element LED may be initialized by the third power voltage VINT.

When the second transistor T2 and the third transistor T3 are concurrently (e.g., simultaneously or substantially simultaneously) turned on in response to the i-th scan signal S[i] and the sensing scan signal SEN[i], a voltage difference between the data signal VDATA and the third power voltage VINT may be stored in the storage capacitor Cst, and the first transistor T1 may control an amount of current flowing through the light emitting element LED in response to the voltage difference stored in the storage capacitor Cst.

When the third transistor T3 maintains the second node N2 and the k-th readout line RLk in a connected state in response to the sensing scan signal SEN[i], the sensing signal (or the current amount) corresponding to the voltage difference (that is, the voltage difference between the data signal VDATA and the third power voltage VINT) may be output from the pixel PXL through the k-th readout line RLk. For example, when the first transistor T1 is turned on by a test signal (for example, a test signal or test voltage applied as a data signal VDATA) in the sensing period, a current flowing in the first transistor T1 in response to the test signal may be output as a sensing signal through the k-th readout line RLk.

In some embodiments of the present disclosure, the pixel PXL is not limited to the circuit structure shown in FIG. 2. In addition to the circuit illustrated in FIG. 2, the pixels PXL may be implemented in various suitable ways.

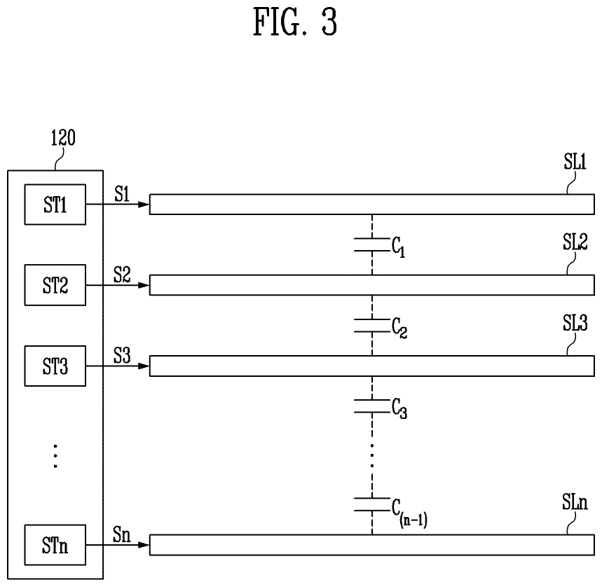

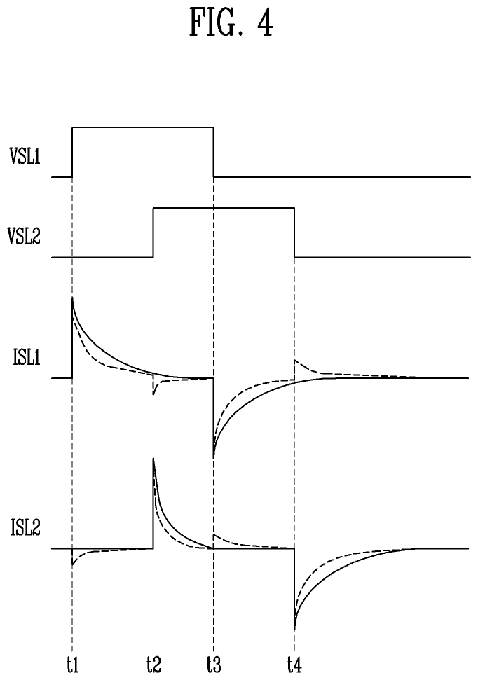

FIG. 3 is a drawing for explaining coupling capacitance between scan lines in the display device of FIG. 1 according to some embodiments of the present disclosure. FIG. 4 illustrates a timing diagram of a current of an adjacent scan line by coupling capacitance when a voltage of the scan line changes according to some embodiments of the present disclosure. Hereinafter, the description will be given with reference to FIG. 3 and FIG. 4 together.

Referring to FIG. 3, a plurality of stages (ST1, ST2, . . . , STn) included in the scan driver 120 and scan lines (SL1, SL2, . . . , SLn) connected to respective stages are illustrated. The plurality of stages (ST1, ST2, . . . , STn) may be configured to 1 respectively supply scanning signals (S1, S2, . . . , Sn) to the corresponding scan lines (SL1, SL2, . . . , SLn).

For example, a coupling capacitance (C1, C2, . . . , C₍ₙ₋₁₎) may be formed between respective scan lines (SL1, SL2, . . . , SLn). As the resolution of the display portion 110 increases, the density of the pixels PXL may increase, and accordingly, the spacing between the scan lines (SL1, SL2, . . . , SLn) also may become narrower. Thus, respective scan lines (SL1, SL2, . . . , SLn) may be substantially affected by the coupling capacitance formed between adjacent scan lines.

Referring to FIG. 4, a timing diagram for explaining the coupling capacitance formed between the first scan line SL1 and the second scan line SL2 is illustrated as an example. In FIG. 4, a first voltage VSL1 of the first scan line SL1, a second voltage VSL2 of the second scan line SL2, a first current ISL1 of the first scan line SL1, and a second current ISL2 of the second scan line SL2 are illustrated. In FIG. 4, a current in an ideal case in which no coupling capacitance is formed between the first scan line SL1 and the second scan line SL2 is shown in a solid line, and a current in a case in which the first scan line SL1 and the second scan line SL2 are affected by a coupling capacitance C1 is shown in a dotted line.

At a time t1, the first voltage VSL1 of the first scan line SL1 increases. Accordingly, the first current ISL1 may flow through the first scan line SL1 at time t1. Due to the coupling capacitance C1, the amount of the first current ISL1 flowing through the first scan line SL1 at actual time t1 may be less than an ideal case.

For example, at time t1, in an ideal case, no current flows through the second scan line SL2, but in reality, a current may flow through the second scan line SL2 by the coupling capacitance C1. In this case, a direction of the current flowing through the second scan line SL2 may be a direction opposite to the current flowing through the first scan line SL1.

At time t2, the second voltage VSL2 of the second scan line SL2 increases. Accordingly, the second current ISL2 may flow through the second scan line SL2 at time t2. Due to the coupling capacitance C1, the amount of the second current ISL2 flowing through the second scan line SL2 at actual time t2 may less than an ideal case.

At time t2, the amount of the first current ISL1 flowing through the first scan line SL1 may decrease due to the coupling capacitance C1.

Similarly, at time t3 and time t4, the current flowing through the first scan line SL1 and the second scan line SL2 is affected by the voltage of the adjacent scan line. Because the scan signals are sequentially supplied to the third to n-th scan lines SL3 to SLn, the current flowing through each scan line may also be affected by the voltages of adjacent scan lines.

A change in current, such as that shown by a dotted line in FIG. 4 may act as noise, and when the display portion 110 is driven, the display quality of the image may be deteriorated by the current or voltage noise of the scan lines. For example, when moisture penetrates into some positions of the wiring of the scan lines of the display portion 110, the coupling capacitance between specific scan lines may be relatively large, which may act as noise when the corresponding scan line is driven and be visually recognized by the user as a horizontal line in the form of a dark line or a bright line.

According to some other embodiments of the present disclosure, when a test voltage is sequentially applied to the scan lines, a current occurring in adjacent scan lines is sensed, and the received image data is compensated based on the current. Therefore, even when the coupling capacitance of a specific scan line among the scan lines is abnormally large, it is possible to prevent or substantially reduce noise in the form of dark or bright lines from being visually recognized by the user by utilizing data compensation.

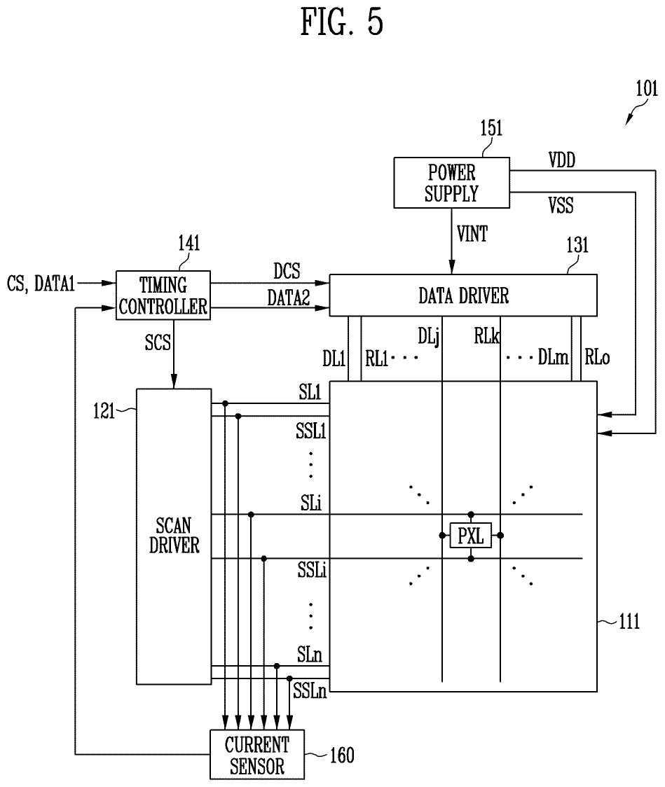

FIG. 5 illustrates a display device according to some other embodiments of the present disclosure.

Referring to FIG. 5, a display device 101 may include a display portion 111 (or display panel), a scan driver 121 (or gate driver), a data driver 131 (or source driver), a timing controller 141, a power supply 151, and a current sensor 160. The display portion 111 (or display panel), the scan driver 121, the data driver 131, and the power supply 151 of FIG. 5 may operate in substantially the same manner as the display portion 110 (or display panel), the scan driver 120, the data driver 130, and the power supply 150 of FIG. 1, respectively. Therefore, redundant descriptions of these components will be omitted.

In some embodiments, the current sensor 160 may be configured to sense a current flowing through each of the plurality of scan lines SL1 to SLn connected between the scan driver 121 and the display portion 111. In some other embodiments, the current sensor 160 may be configured to sense a current flowing through each of the sensing scan lines SSL1 to SSLn connected between the scan driver 121 and the display portion 111. In still some other embodiments, the current sensor 160 may be configured to sense a current flowing through each of the plurality of scan lines SL1 to SLn and the plurality of sensing scan lines SSL1 to SSLn connected between the scan driver 121 and the display portion 111.

The current sensor 160 may sense a current flowing through each of the plurality of scan lines SL1 to SLn to generate coupling current information ICS corresponding to each scan line and transmit the generated coupling current information ICS to the timing controller 141.

The timing controller 141 may generate the image data DATA2 by compensating and converting the input image data DATA1 based on the received coupling current information ICS. The generated image data DATA2 may be transmitted to the data driver 130. Because the image data DATA2 is compensated based on the coupling current information ICS, noise due to coupling between the scan lines may be significantly lessened or removed from the image displayed on the display portion 111 by the image data DATA2. Accordingly, the quality of the image displayed on the display portion 111 may be improved.

In some other embodiments, the current sensor 160 may sense a current flowing through each of the plurality of sensing scan lines SSL1 to SSLn to generate coupling current information ICS corresponding to each sensing scan line and transmit the generated coupling current information ICS to the timing controller 141. In still some other embodiments, the current sensor 160 may sense all currents flowing through the plurality of scan lines SL1 to SLn and the plurality of sensing scan lines SSL1 to SSLn to generate coupling current information ICS corresponding to each scan line and each sensing scan line and transmit the generated coupling current information ICS to the timing controller 141. Hereinafter, for better understanding and ease of description, the present disclosure will be described based on embodiments in which the current sensor 160 generates the coupling current information ICS by sensing the current of the scan lines SL1 to SLn.

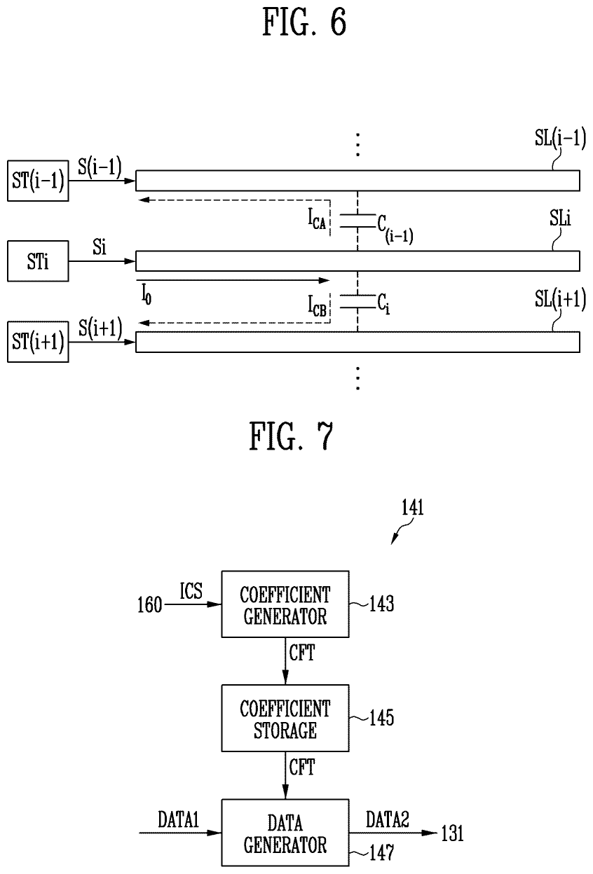

FIG. 6 is a drawing for explaining a method for sensing a coupling current in the display device of FIG. 5 according to some embodiments of the present disclosure. More specifically, FIG. 6 illustrates a method of generating coupling current information corresponding to the i-th scan line SLi among the first to n-th scan lines SL1 to SLn.

In FIG. 6, only the (i−1)-th scan line SL(i−1), the i-th scan line SLi, and the (i+1)-th scan line SL(i+1) among the plurality of scan lines SL1 to SLn are illustrated. This is because capacitances other than the adjacent coupling capacitances C₍ᵢ₋₁₎ and Cᵢ among the coupling capacitances affecting the i-th scan line SLi are so small that their effect can be ignored. That is, in some embodiments of the present disclosure, the coupling current information corresponding to the i-th scan line SLi may be determined based on the current flowing in the (i−1)-th scan line SL(i−1) and the (i+1)-th scan line SL(i+1) disposed adjacent to the i-th scan line SLi when a reference voltage is applied to the i-th scan line SLi.

For example, to generate (e.g., determine) the coupling current information corresponding to the i-th scan line SLi, a set reference voltage (e.g., a preset or predetermined reference voltage) may be applied to the ith scan line SLi. In this case, a current I₀ may flow through the i-th scan line SLi corresponding to the applied reference voltage.

In addition, a coupling current I_{CA} may flow from the (i−1)-th scan line SL(i−1) to the (i−1)-th stage ST(i−1) by the coupling capacitance C(i−1) between the i-th scan line SLi and the (i−1)-th scan line SL(i−1). A coupling current I_{CB} may flow from the (i+1)-th scan line SL(i+1) to the (i)-th stage ST(i+1) by the coupling capacitance Cᵢ between the i-th scan line SLi and the (i+1)-th scan line SL(i+1).

The current sensor 160 may generate coupling current information corresponding to the i-th scan line SLi based on the coupling current I_{CA} flowing from the (i−1)-th scan line SL(i−1) to the (i−1)-th stage ST(i−1) and the coupling current I_{CB} flowing from the (i+1)-th scan line SL(i+1) to the (i+1)-th stage ST(i+1)

In some embodiments, the coupling current information corresponding to the i-th scan line SLi may be generated by adding the coupling current I_{CA} and the coupling current I_{CB}.

The above process may be performed identically for the first to n-th scan lines SL1 to SLn. However, the coupling current information for the first scan line SL1 may be generated by sensing the coupling current flowing through the second scan line SL2, and the coupling current information for the n-th scan line SLn may be generated by sensing the coupling current flowing through the (n−1)-th scan line SL(n−1).

FIG. 7 illustrates a block diagram of a timing controller of FIG. 3 according to some embodiments of the present disclosure.

Referring to FIG. 7, the timing controller 141 may include a coefficient generator 143, a coefficient storage 145, and a data generator 147.

The coefficient generator 143 may generate a correction coefficient corresponding to each of the scan lines SL1 to SLn based on the received coupling current information. For example, the coupling current information ICS received by the coefficient generator 143 may include first to n-th coupling current information corresponding to the first to n-th scan lines SL1 to SLn, respectively, and the coefficient generator 143 may generate correction coefficients corresponding to the first to nth scan lines SL1 to SLn, respectively, based on the first to n-th coupling current information.

To this end, the coefficient generator 143 may include a first lookup table including a relationship between correction coefficients corresponding to a value of the input coupling current information. For example, the first lookup table may be configured as shown in Table 1 below.

TABLE 1

| Coupling current range | Correction factor |
|---|---|
| 0 ≤ ICS < Iₐ | VALa |
| Iₐ ≤ ICS < I_{b} | VALb |
| I_{b} ≤ ICS < I_{c} | VALc |
| . . . | . . . |
| Iₚ ≤ ICS < I_{q} | VALq |

That is, the coefficient generator 143 may determine a correction coefficient of the corresponding scan line based on the value of the received coupling current information ICS with reference to the first lookup table in a format as shown in Table 1. For example, when the value of the coupling current information ICS corresponding to the eighth scan line SL8 is within the range greater than or equal to I_{b} and less than i_{c}, the coefficient generator 143 may determine the correction coefficient corresponding to the eighth scan line SL8, that is, the value of the eighth correction coefficient CFT₈ as VALc. Thereafter, the eighth correction coefficient CTF₈ having the value of VALc may be transmitted to the coefficient storage 145. The coefficient generator 143 may sequentially generate first to n-th correction coefficients CFT₁ to CFTₙ corresponding to each of the first to n-th scan lines SL1 to SLn, and store the generated first to n-th correction coefficients CFT₁ to CFTₙ in the coefficient storage 145.

The coefficient storage 145 may store the received first to n-th correction coefficients CFT₁ to CFTₙ. In some embodiments, the coefficient storage 145 may store a second lookup table including a relationship between the scan lines SL1 to SLn and the correction coefficients CFT₁ to CFTₙ respectively corresponding thereto in a format shown in Table 2 below.

TABLE 2

| Scan line | Correction factor |
|---|---|
| SL1 | CFT₁ |
| SL2 | CFT₂ |
| SL3 | CFT₃ |
| . . . | . . . |
| SLn | CFTₙ |

The data generator 147 may receive input image data DATA1 from an external device (e.g., a graphic processor) and receive a correction coefficient CFT from the coefficient storage 145. As described above, the data generator 147 may receive the correction coefficient CFT in the form of the second lookup table as shown in Table 2. The data generator 147 may generate image data DATA2 from the input image data DATA1 with reference to the correction coefficient CFT.

For example, the input image data DATA1 may include a plurality of grayscale data corresponding to respective pixels PXL. The data generator 147 may generate corrected grayscale data by applying a correction coefficient corresponding to grayscale data corresponding to respective pixels PXL. The corrected grayscale data may be included in the image data DATA2.

For example, the data generator 147 may generate corrected grayscale data corresponding to the first scan line SL1 by applying the first correction coefficient CFT₁ to grayscale data corresponding to the pixels connected to the first scan line SL1. In addition, the data generator 147 may generate corrected grayscale data corresponding to the second scan line SL2 by applying the second correction coefficient CFT₂ to grayscale data corresponding to the pixels connected to the second scan line SL2. In this way, the data generator 147 may generate the corrected grayscale data by applying the first to nth correction coefficients CFT₁ to CFTₙ to the grayscale data respectively corresponding to the first to n-th scan lines SL1 to SLn. Finally, the image data DATA2 including the corrected grayscale data may be generated.

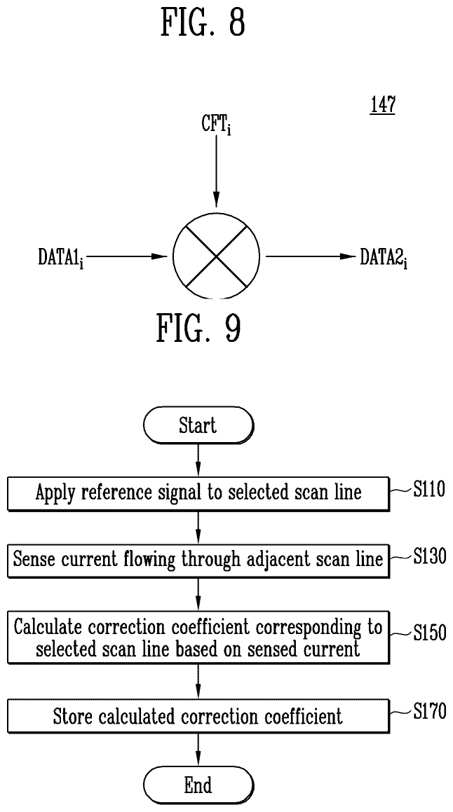

FIG. 8 illustrates a block diagram of a data generator of FIG. 7 according to some embodiments of the present disclosure.

Referring to FIG. 8, the data generator 147 may generate the i-th image data DATA2ᵢ by multiplying the i-th input image data DATA1ᵢ by the i-th correction coefficient CFTᵢ. The i-th input image data DATA1ᵢ may be one of grayscale data included in the i-th scan line SLi, and the i-th correction coefficient CFTᵢ may be a correction coefficient corresponding to the i-th scan line SLi. In some embodiments, the i-th correction coefficient CFTᵢ may be a value greater than 0 and less than 1. When the coupling capacitance value between the scan lines increases, the pixels connected to the corresponding scan lines may be visually recognized in the form of bright lines. By multiplying the pixels of the i-th scan line SLi visually recognized in the form of bright lines by the i-th correction coefficient CFTᵢ having a value greater than 0 and less than 1, the bright line visualization problem may be reduced.

In some embodiments, the i-th correction coefficient CFTᵢ may have a value of about 1. This means that in the current sensing process described with reference to FIG. 6, the coupling currents I_{CA} and I_{CB} flowing through adjacent scan lines are negligibly small.

In some embodiments, the i-th correction coefficient CFTᵢ may be a value greater than 1. When the coupling capacitance value between the sensing scan lines increases, the pixels connected to the corresponding sensing scan lines may be visually recognized in the form of dark lines. By multiplying the pixels of the i-th sensing scan line SSLi visually recognized in the form of dark lines by the i-th correction coefficient CFTᵢ having a value greater than 1, the dark line visualization problem may be reduced.

FIG. 9 illustrates a flowchart of an operating method of a display device according to some other embodiments of the present disclosure. More specifically, FIG. 9 is a flowchart for describing a method of calculating a coupling current corresponding to each of the scan lines SL1 to SLn and storing a correction coefficient.

Referring to FIG. 9, an operating method of a display device includes applying a reference signal to a selected scan line (e.g., the i-th scan line SLi) (S110), sensing a current flowing through adjacent scan lines (e.g., the (i−1)-th scan line SL(i−1) and the (i+1)-th scan line SL(i+1)) (S130), calculating a correction coefficient corresponding to the selected scan line based on the sensed current (S150), and storing the calculated correction coefficient (S170). Hereinafter, the flowchart of FIG. 9 will be described based on a case in which the selected scan line is the i-th scan line SLi.

The scan driver 121 applies a set (e.g., preset or predetermined) reference voltage to the i-th scan line SLi (S110). The current sensor 160 senses the coupling current I_{CA} flowing in the (i−1)-th scan line SL(i−1) and the coupling current I_{CB} flowing in the (i+1)-th scan line SL(i+1) (S130). In some embodiments, the current sensor 160 may transmit a value obtained by summing the coupling currents I_{CA} and I_{CB} to the timing controller 141 (e.g., timing control unit) as the coupling current information ICS corresponding to the ith scan line SLi.

The coefficient generator 143 included in the timing controller 141 may calculate a correction coefficient corresponding to the i-th scan line SLi based on the coupling current information ICS (S150). In step S150, the coefficient generator 143 may determine the value of the correction coefficient corresponding to the range of the value of the coupling current information ICS with reference to the first lookup table in the form of Table 1 described above. The coefficient generator 143 transmits the calculated correction coefficient to the coefficient storage 145.

The coefficient storage 145 may store a correction coefficient corresponding to the i-th scan line SLi (S170). As described above, the coefficient storage 145 may store the correction coefficient in the form of the second lookup table as shown in Table 2.

As described above, step S110 to step S170 of FIG. 9 may be performed on each of the first to n-th scan lines SL1 to SLn. Accordingly, correction coefficients respectively corresponding to the first to n-th scan lines SL1 to SLn may be stored in the coefficient storage 145.

In some embodiments, step S110 to step S170 illustrated in FIG. 9 may be performed when the display device 101 is turned on. That is, during the initialization operation of the display device 101, the coupling currents for respective scan lines may be sensed, so that correction coefficients corresponding to respective scan lines may be set. However, the present disclosure is not limited thereto, and step S110 to step S170 shown in FIG. 9 may be periodically performed during the operation of the display device 101.

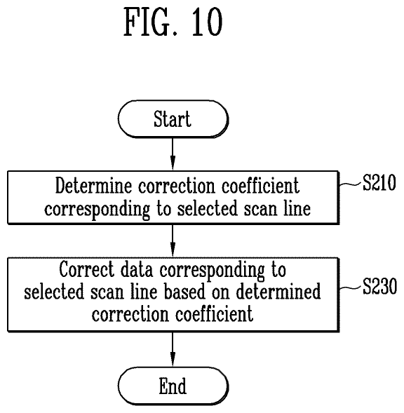

FIG. 10 illustrates a flowchart of an operating method of a display device according to some other embodiments of the present disclosure. More specifically, FIG. 10 illustrates a flowchart for explaining a method for correcting input image data corresponding to each of the scan lines SL1 to SLn.

Referring to FIG. 10, an operating method of a display device includes determining a correction coefficient (e.g., the i-th correction coefficient CFTᵢ) corresponding to a selected scan line (e.g., the i-th scan line SLi) (S210) and correcting data corresponding to the selected scan line based on the determined correction coefficient (S230). Hereinafter, the flowchart of FIG. 10 will be described based on a case in which the selected scan line is the i-th scan line SLi.

The data generator 147 may receive the input image data DATA1ᵢ corresponding to the i-th scan line SLi and determines a value of the i-th correction coefficient CFTᵢ corresponding to the i-th scan line SLi (S210). In this process, the data generator 147 may determine the value of the i-th correction coefficient CFTᵢ with reference to the second lookup table in the form shown in Table 2.

The data generator 147 may correct the input image data DATA1ᵢ corresponding to the i-th scan line SLi by reflecting the determined i-th correction coefficient CFTᵢ (S230). For example, as described with reference to FIG. 8, the data generator 147 may generate the i-th image data DATA2ᵢ by multiplying the i-th input image data DATA1ᵢ by the i-th correction coefficient CFTᵢ.

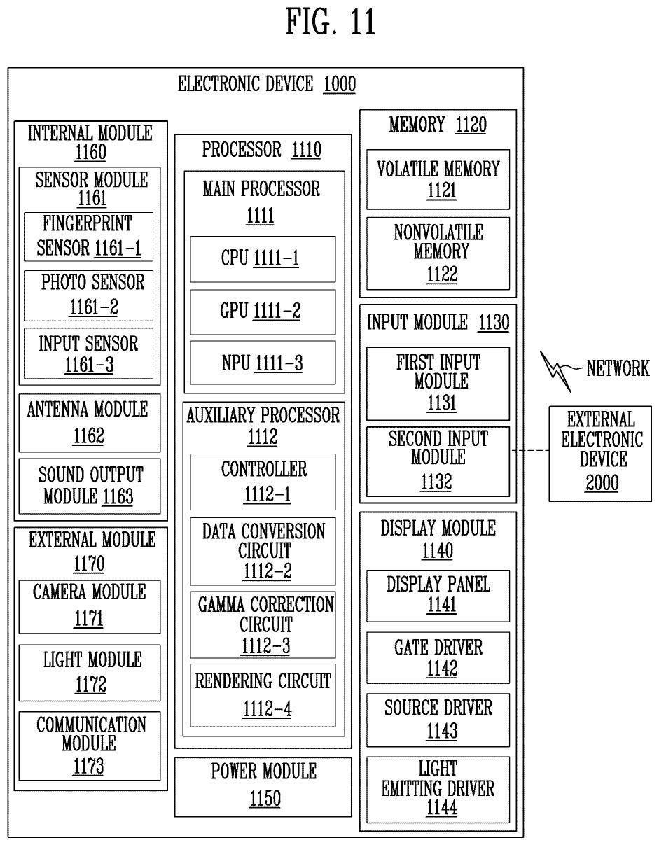

FIG. 11 illustrates an electronic device according to some other embodiments of the present disclosure.

Referring to FIG. 11, the electronic device according to some embodiments of the present disclosure outputs various information through a display module 1140. The display module 1140 may correspond to at least some of the display device 100 or 101 of FIG. 1 or FIG. 5. When a processor 1110 executes an application stored in a memory 1120, the display module 1140 may provide application information to a user through a display panel 1141. The display panel 1141 may have a configuration corresponding to the display portion 110 or 111 of FIG. 1 or FIG. 5.

The processor 1110 may obtain external input through an input module 1130 or a sensor module 1161 and may execute an application corresponding to the external input. For example, when the user selects a camera icon displayed on the display panel 1141, the processor 1110 may obtain user input through an input sensor 1161-3 and activate the camera module 1171. The processor 1110 may transmit image data corresponding to a captured image obtained through the camera module 1171 to the display module 1140. The display module 1140 may display an image corresponding to the captured image through the display panel 1141.

As another example, when personal information authentication is executed in the display module 1140, a fingerprint sensor 1161-1 may obtain inputted fingerprint information as input data. The processor 1110 may compare the inputted data obtained through the fingerprint sensor 1161-1 with authentication data stored in the memory 1120, and may execute an application according to the compared result. The display module 1140 may display information executed according to application logic through the display panel 1141.

As another example, when a music streaming icon displayed on the display module 1140 is selected, the processor 1110 may obtain user input through the input sensor 1161-3 and activate a music streaming application stored in the memory 1120. When a music execution instruction is inputted from the music streaming application, the processor 1110 may activate a sound output module 1163 to provide sound information corresponding to the music execution instruction to the user.

In the above, the operation of the electronic device 1000 has been briefly described. Hereinafter, a configuration of the electronic device 1000 will be described in detail. Some of components of the electronic device 1000 to be described later may be integrated and provided as one component, and one component thereof may be divided and provided as two or more components.

The electronic device 1000 may communicate with an external electronic device 2000 through a network (e.g., a short range wireless communication network or a long range wireless communication network). According to some embodiments, the electronic device 1000 may include the processor 1110, the memory 1120, an input module 1130, the display module 1140, a power module 1150, an internal module 1160 (e.g., an embedded module), and an external module 1170. According to some embodiments, in the electronic device 1000, at least one of the aforementioned constituent elements may be omitted, or one or more other constituent elements may be added. According to some embodiments, some (e.g., the sensor module 1161, an antenna module 1162, or a sound output module 1163) of the aforementioned constituent elements may be integrated into another constituent element (e.g., the display module 1140).

The processor 1110 may execute software to control at least one other constituent element (e.g., a hardware or software constituent element) of the electronic device 1000 connected to the processor 1110, and may perform various data processing or calculations. According to some embodiments, as at least some of the data processing or operation, the processor 1110 may store an instruction or data received from other constituent element (e.g., the input module 1130, the sensor module 1161, or a communication module 1173) in a volatile memory 1121, may process the instructions or data stored in the volatile memory 1121, and may store the result data in a non-volatile memory 1122.

The processor 1110 may include a main processor 1111 and an auxiliary processor 1112. The auxiliary processor 1112 may correspond to at least some of components of the timing controller 140 or 141 of FIG. 1 or FIG. 5.

The main processor 1111 may include one or more of a central processing unit (CPU) 1111-1 and an application processor (AP). The main processor 1111 may further include one or more of a graphic processing unit (GPU) 1111-2, a communication processor (CP), and an image signal processor (ISP). The main processor 1111 may further include a neural processing unit (NPU) 1111-3. The neural processing unit is a processor specialized in processing an artificial intelligence model, and the artificial intelligence model may be generated through machine learning. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, and a combination of two or more thereof, but is not limited to the above example. The artificial intelligence models may additionally or alternatively include a software structure in addition to the hardware structure thereof. At least two of the aforementioned processing unit and processor may be implemented as an integrated component (e.g., a single chip), or each thereof may be implemented as an independent component (e.g., a plurality of chips).

The auxiliary processor 1112 may include a controller 1112-1. The controller 1112-1 may include an interface conversion circuit and a timing control circuit. The controller 1112-1 may receive an image signal from the main processor 1111, and convert a data format of the image signal to meet an interface specification with the display module 1140 to output image data.

The auxiliary processor 1112 may further include a data conversion circuit 1112-2, a gamma correction circuit 1112-3, a rendering circuit 1112-4, and the like. The data conversion circuit 1112-2 may receive image data from the controller 1112-1, and it may compensate the image data to display the image with a desired luminance according to characteristics of the electronic device 1000 or a user's setting, or convert the image data to reduce power consumption or compensate for an afterimage.

The gamma correction circuit 1112-3 may convert the image data or gamma reference voltage so that the image displayed on the electronic device 1000 has a desired gamma characteristic. The rendering circuit 1112-4 may receive image data from the controller 1112-1 and render the image data in consideration of pixel disposition of the display panel 1141 applied to the electronic device 1000. At least one of the data conversion circuit 1112-2, the gamma correction circuit 1112-3, and the rendering circuit 1112-4 may be incorporated into another constituent element (e.g., the main processor 1111 or the controller 1112-1). At least one of the data conversion circuit 1112-2, the gamma correction circuit 1112-3, and the rendering circuit 1112-4 may be integrated into a source driver 1143 to be described later.

The memory 1120 may store various data used by at least one constituent element (e.g., the processor 1110 or the sensor module 1161) of the electronic device 1000, and input data or output data for an instruction related thereto. The memory 1120 may include at least one or more of the volatile memory 1121 and the non-volatile memory 1122.

The input module 1130 may receive an instruction or data to be used for a constituent element (e.g., the processor 1110, the sensor module 1161, or the sound output module 1163) of the electronic device 1000 from the outside of the electronic device 1000 (e.g., a user or the external electronic device 2000).

The input module 1130 may include a first input module 1131, to which an instruction or data is inputted from a user, and a second input module 1132, to which an instruction or data is inputted from the external electronic device 2000. The first input module 1131 may include a microphone, a mouse, a keyboard, a key (e.g., a button), or a pen (e.g., a passive pen or active pen). The second input module 1132 may support a designated protocol that may be connected to the external electronic device 2000 either by wire or wirelessly. According to some embodiments, the second input module 1132 may include a high definition multimedia interface (HDMI), a universal serial bus (USB) interface, an SD card interface, an audio interface, and/or the like. The second input module 1132 may include a connector that may be physically connected to the external electronic device 2000, for example, an HDMI connector, a USB connector, an SD card connector, or an audio connector (e.g., a headphone connector).

The display module 1140 may visually provide information to the user. The display module 1140 may include a display panel 1141, a gate driver 1142, a source driver 1143, and alight emitting driver 1144. The gate driver 1142 may correspond to at least a portion of the scan driver 120 or 121 shown in FIG. 1 or FIG. 5. The source driver 1143 may correspond to at least a portion of the data driver 130 or 131 shown in FIG. 1 or FIG. 5. The display module 1140 may further include a window, a chassis, and a bracket to protect the display panel 1141.

The display panel 1141 (e.g., a display) may include a liquid crystal display panel, an organic light emitting display panel, or an inorganic light emitting display panel, and the type of display panel 1141 is not particularly limited. The display panel 1141 may be a rigid type, or a flexible type that may be rolled or folded. The display module 1140 may further include a supporter, a bracket, or a heat dissipation member for supporting the display panel 1141.

The gate driver 1142 may be mounted on the display panel 1141 as a driving chip. In addition, the gate driver 1142 may be integrated in the display panel 1141. For example, the gate driver 1142 includes an amorphous silicon TFT gate driver circuit (ASG), a low temperature polycrystalline silicon (LTPS) TFT gate driver circuit, or an oxide semiconductor TFT gate driver circuit (OSG) that is embedded in the display panel 1141.

The light emitting driver 1144 may be mounted on the display panel 1141 as a driving chip. In addition, the light emitting driver 1144 may be integrated into the display panel 1141, similar to the gate driver 1142. The light emitting driver 1144 may be formed separately from the gate driver 1142, or may be integrated in the gate driver 1142. Additionally, the light emitting driver 1144 may generate a light emitting control signal in response to a light emitting start signal supplied from a start signal controller 516.

The source driver 1143 may be integrated into other constituent elements (e.g., the controller 1112-1). The functions of the interface conversion circuit and the timing control circuit of the controller 1112-1 described above may be integrated into the source driver 1143.

The display module 1140 may further include a voltage generation circuit. The voltage generating circuit may output various voltages suitable for driving the display panel 1141. In some embodiments, the display panel 1141 may include a plurality of pixel arrays each including a plurality of pixels.

In some embodiments, the source driver 1143 may convert data (e.g., output data) corresponding to red (R), green (G), and blue (B) included in the image data received from the processor 1110 into a red data signal (or data voltage), a green data signal, and a blue data signal to provide them to the plurality of pixel arrays included in the display panel 1141 during one horizontal period.

The power module 1150 may supply power to the constituent elements of the electronic device 1000. The power module 1150 may include a battery in which a power voltage is charged. The battery may include a non-rechargeable primary battery, or a rechargeable battery or fuel cell. The power module 1150 may include a power management integrated circuit (PMIC). The PMIC may supply suitable power to each of the above-described modules and modules to be described later. The power module 1150 may include a wireless power transmission/reception member electrically connected to a battery. The wireless power transmission/reception member may include a plurality of antenna radiators in a form of a coil. The power module 1150 may be implemented to include the power supply 150 or 151 of FIG. 1 or FIG. 5. In some embodiments, the power module 1150 may be implemented to include the current sensor 160 of FIG. 5.

The electronic device 1000 may further include an internal module 1160 and an external module 1170. The internal module 1160 may include the sensor module 1161, the antenna module 1162, and the sound output module 1163. The external module 1170 may include a camera module 1171, a light module 1172, and the communication module 1173.

The sensor module 1161 may sense input by a user's body or input by the pen among the first input module 1131, and may generate an electrical signal or a data value corresponding to the input. In addition, the sensor module 1161 may detect an external environment (e.g., illuminance, temperature, and the like) and generate an electrical signal or data value corresponding to the external environment.

The sensor module 1161 may include at least one or more of the fingerprint sensor 1161-1, the photo sensor 1161-2, and the input sensor 1161-3. The fingerprint sensor 1161-1 may generate a data value corresponding to a user's fingerprint. The fingerprint sensor 1161-1 may include either an optical type or a capacitive type fingerprint sensor.

The photo sensor 1161-2 (or illuminance sensor) may sense external illuminance and provide an electrical signal or data value corresponding to the sensed illuminance to the auxiliary processor 1112 (or processor 1110). Additionally, the photo sensor 1161-2 may provide a photo sensing signal to the controller 1112-1 at a time when illuminance is sensed. The controller 1112-1 receiving the photo sensing signal may control the number of off periods included in the light emitting start signal. For example, when the photo sensing signal is supplied, the controller 1112-1 may control the light emitting start signal to include an off period of a smaller number of light emitting control signals in one frame period of the second driving frequency.

The input sensor 1161-3 may generate a data value corresponding to coordinate information of input by the user's body or input by the pen. The input sensor 1161-3 may generate an amount of change in capacitance by the input as a data value. The input sensor 1161-3 may sense input by the passive pen, or may transmit/receive data with the active pen.

The input sensor 1161-3 may measure a biosignal, such as blood pressure, water, or body fat. For example, when the user touches a part of the body to the sensor layer or the sensing panel and does not move for a certain period of time, based on a change in an electric field by the part of the body, the input sensor 1161-3 may sense a biosignal and output desired information to the display module 1140.

The sensor module 1161 may further include a digitizer. The digitizer may generate a data value corresponding to coordinate information of a pen input. The digitizer may generate the amount of electromagnetic change by the input as a data value. The digitizer may sense input by the passive pen, or may transmit/receive data with the active pen.

At least one of the fingerprint sensor 1161-1, the photo sensor 1161-2, and the input sensor 1161-3 may be implemented as a sensor layer disposed on the display panel 1141 through a continuous process.

At least two or more of the fingerprint sensor 1161-1, the photo sensor 1161-2, and the input sensor 1161-3 may be formed to be integrated into one sensing panel through the same process. When integrated into one sensing panel, the sensing panel may be disposed between the display panel 1141 and a window disposed at an upper side of the display panel 1141. According to some embodiments, the sensing panel may be disposed on the window, and the position of the sensing panel is not particularly limited.

At least one of the fingerprint sensor 1161-1, the photo sensor 1161-2, and the input sensor 1161-3 may be embedded in the display panel 1141. That is, at least one of the fingerprint sensor 1161-1, the photo sensor 1161-2, and the input sensor 1161-3 may be concurrently formed (e.g., simultaneously formed) through the process of forming elements (e.g., a light emitting element, a transistor, and the like) included in the display panel 1141.

In addition, the sensor module 1161 may generate an electrical signal or a data value corresponding to an internal state or an external state of the electronic device 1000. The sensor module 1161 may further include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, or a humidity sensor.

The antenna module 1162 may include one or more antennas for transmitting or receiving a signal or power to or from the outside. According to some embodiments, the communication module 1173 may transmit a signal to an external electronic device or receive a signal from an external electronic device through an antenna suitable for a communication method. An antenna pattern of the antenna module 1162 may be integrated into one component (e.g., the display panel 1141) of the display module 1140 or the input sensor 1161-3.

The sound output module 1163 is a device for outputting a sound signal to the outside of the electronic device 1000, and may include, for example, a speaker used for general purposes, such as multimedia playback or recording playback, and a receiver used exclusively for receiving calls. According to some embodiments, the receiver may be provided integrally with or separately from the speaker. A sound output pattern of the sound output module 1163 may be integrated into the display module 1140.

The camera module 1171 may capture still images and moving images. According to some embodiments, the camera module 1171 may include one or more lenses, image sensors, and/or image signal processors. The camera module 1171 may further include an infrared camera capable of measuring the presence or absence of the user, the position of the user, and the gaze of the user.

The light module 1172 may provide light. The light module 1172 may include a light emitting diode or a xenon lamp. The light module 1172 may operate in conjunction with the camera module 1171 or may operate independently.

The communication module 1173 may support establishment of a wired or wireless communication channel between the electronic device 1000 and the external electronic device 2000, and communication through the established communication channel. The communication module 1173 may include one or both of a wireless communication module, such as a cellular communication module, a short range communication module, or a global navigation satellite system (GNSS) communication module and a wired communication module, such as a local area network (LAN) communication module or a power line communication module. The communication module 1173 may communicate with the external electronic device 2000 through a short range communication network, such as Bluetooth, WiFi direct, infrared data association (IrDA), or the like or a long range communication network, such as a cellular network, the Internet, a computer network (e.g., LAN or WAN), or the like. The various types of the communication modules 1173 described above may be implemented as a single chip or may be implemented as separate chips.

The input module 1130, the sensor module 1161, the camera module 1171, and the like may be used to control an operation of the display module 1140 in conjunction with the processor 1110.

The processor 1110 may output an instruction or data to the display module 1140, the sound output module 1163, the camera module 1171, and/or the light module 1172 based on input data received from the input module 1130. For example, the processor 1110 may generate image data in response to input data applied through a mouse or an active pen to output it to the display module 1140, or may generate instruction data in response to the input data to output it to the camera module 1171 or light module 1172. When input data is not received from the input module 1130 for a certain period of time, the processor 1110 may reduce power consumed by the electronic device 1000 by changing an operation mode of the electronic device 1000 to a low power mode or a sleep mode.

The processor 1110 may output an instruction or data to the display module 1140, the sound output module 1163, the camera module 1171, and/or the light module 1172 based on sensing data received from the sensor module 1161. For example, the processor 1110 may compare authentication data applied by the fingerprint sensor 1161-1 with authentication data stored in the memory 1120 and then execute an application according to the compared result. The processor 1110 may execute an instruction based on sensed data sensed by the input sensor 1161-3, or may output corresponding image data to the display module 1140. The processor 1110 may control the luminance of the display panel 1141 in response to the illuminance sensed by the photo sensor 1161-2. When the sensor module 1161 includes a temperature sensor, the processor 1110 may receive temperature data for a measured temperature from the sensor module 1161, and may further perform luminance correction on image data based on the temperature data.

The processor 1110 may receive measurement data about the presence of a user, a user's position, a user's gaze, and the like, from the camera module 1171. The processor 1110 may further perform luminance correction and the like on image data based on the measurement data. For example, the processor 1110 that determines the presence of a user through an input from the camera module 1171 may output image data whose luminance is corrected through the data conversion circuit 1112-2 or the gamma correction circuit 1112-3 to the display module 1140.

Some of the above constituent elements may be connected to each other through a communication method between peripheral devices, for example, a bus, a general purpose input/output (GPIO), a serial peripheral interface (SPI), a mobile industry processor interface (MIPI), an ultra path interconnect (UPI) link, and/or the like to exchange a signal (e.g., an instruction or data) with each other. The processor 1110 may communicate with the display module 1140 through a mutually agreed interface. For example, the processor 1110 may use one of the above-described communication methods, but is not limited to the above-described communication methods.

The electronic device 1000 according to various embodiments disclosed in the present specification may be devices of various types. The electronic device 1000 may include, for example, at least one of a portable communication device (e.g., a smartphone), a computer device, a portable multimedia device, a portable medical device, a camera, a wearable device, a home appliance, or the like. The electronic device 1000 according to some embodiments of the present specification is not limited to the above-described devices.

It should be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and equivalents thereof.

What is claimed is:

1. A display device comprising:
a display panel comprising a plurality of pixels;
a scan driver connected to the display panel through a plurality of scan lines;
a data driver configured to provide a data signal corresponding to each of the plurality of pixels to the display panel;
a timing controller configured to receive image data and to control driving of the scan driver and the data driver to display an image corresponding to the image data; and
a current sensor configured to sense a current flowing through the plurality of scan lines,
wherein the timing controller is configured to correct the image data based on the current flowing through the plurality of scan lines.

2. The display device of claim 1, wherein
the scan driver is configured to apply a set reference voltage to a selected scan line among the plurality of scan lines, and
the current sensor is configured to sense currents flowing through adjacent scan lines adjacent to the selected scan line.

3. The display device of claim 2, wherein the current sensor is configured to: generate coupling current information by adding values of the currents flowing through the adjacent scan lines, and
transmit the coupling current information to the timing controller.

4. The display device of claim 3, wherein the timing controller is configured to:
generate a correction coefficient corresponding to the selected scan line based on the coupling current information, and
correct the image data based on the correction coefficient.

5. The display device of claim 4, wherein the timing controller comprises:
a correction coefficient generator configured to receive coupling current information corresponding to the selected scan line and to generate the correction coefficient corresponding to the selected scan line with reference to a first lookup table;
a correction coefficient storage configured to store the generated correction coefficient; and
a data generator configured to generate corrected grayscale data by multiplying grayscale data corresponding to the selected scan line among the image data by the correction coefficient.

6. The display device of claim 5, wherein the correction coefficient storage is configured to store a plurality of correction coefficient values respectively corresponding to the plurality of scan lines in a second lookup table.

7. The display device of claim 6, wherein
at least one of the plurality of correction coefficient values stored in the second lookup table has a value greater than 0 and less than 1.

8. The display device of claim 1, wherein:
the scan driver is connected to the display panel through the plurality of scan lines and a plurality of sensing scan lines,
the current sensor is configured to sense a current flowing through the plurality of scan lines and a current flowing through the plurality of sensing scan lines, and
the timing controller is configured to correct the image data based on the currents flowing through the plurality of scan lines and the plurality of sensing scan lines.

9. A display device comprising:
a display panel comprising a plurality of pixels;
a scan driver connected to the display panel through a plurality of scan lines and a plurality of sensing scan lines;
a data driver is configured to provide a data signal corresponding to each of the plurality of pixels to the display panel;
a timing controller is configured to receive image data and to control driving of the scan driver and the data driver to display an image corresponding to the image data; and
a current sensor configured to sense a current flowing through the plurality of sensing scan lines,
wherein the timing controller is configured to correct the image data based on the current flowing through the plurality of sensing scan lines.

10. The display device of claim 9, wherein
the scan driver is configured to apply a set reference voltage to a selected sensing scan line among the plurality of sensing scan lines, and
the current sensor is configured to sense currents flowing through adjacent sensing scan lines adjacent to the selected sensing scan line.

11. The display device of claim 10, wherein the current sensor is configured to:
generate coupling current information by adding values of the currents flowing through the adjacent sensing scan lines, and transmit the coupling current information to the timing controller.

12. The display device of claim 11, wherein the timing controller is configured to:
generate a correction coefficient corresponding to the selected sensing scan line based on the coupling current information, and correct the image data based on the correction coefficient.

13. The display device of claim 12, wherein the timing controller comprises: a correction coefficient generator configured to receive coupling current information corresponding to the selected sensing scan line and generate the correction coefficient corresponding to the selected sensing scan line with reference to a first lookup table;
a correction coefficient storage configured to store the generated correction coefficient; and
a data generator configured to generate corrected grayscale data by multiplying grayscale data corresponding to the selected sensing scan line among the image data by the correction coefficient.

14. The display device of claim 13, wherein the correction coefficient storage is configured to store a plurality of correction coefficient values respectively corresponding to the plurality of sensing scan lines in a second lookup table.

15. The display device of claim 14, wherein at least one of the plurality of correction coefficient values stored in the second lookup table has a value greater than 1.

16. An electronic device comprising:
a display panel comprising a plurality of pixels;
a scan driver connected to the display panel through a plurality of scan lines;
a data driver configured to provide a data signal corresponding to each of the plurality of pixels to the display panel;
a controller configured to receive image data and control driving of the scan driver and the data driver to display an image corresponding to the image data; and
a power module configured to sense a current flowing through the plurality of scan lines,
wherein the controller is configured to correct the image data based on the current flowing through the plurality of scan lines.

17. The electronic device of claim 16, wherein the controller comprises: a correction coefficient generator configured to receive coupling current information corresponding to a selected scan line among the plurality of scan lines and generate the correction coefficient corresponding to the selected scan line with reference to a first lookup table;
a correction coefficient storage configured to store the generated correction coefficient; and
a data generator configured to generate corrected grayscale data by multiplying grayscale data corresponding to the selected scan line among the image data by the correction coefficient.

18. The electronic device of claim 17, wherein the correction coefficient storage is configured to store a plurality of correction coefficient values respectively corresponding to the plurality of scan lines in a second lookup table.

19. The electronic device of claim 16, wherein
the scan driver is connected to the display panel through the plurality of scan lines and a plurality of sensing scan lines,
the electronic device further comprises a current sensor configured to sense a current flowing through the plurality of scan lines and a current flowing through the plurality of sensing scan lines, and
wherein the controller is configured to correct the image data based on the currents flowing through the plurality of scan lines and the plurality of sensing scan lines.
